(19) United States
(12) Patent Application Publication
(10) Pub. No.: US 2023/0385923 A1
(43) Pub. Date: Nov. 30, 2023

(54) MULTI-UNIT SEALED-BID AUCTIONS ON THE ETHEREUM VIRTUAL MACHINE

(71) Applicant: Divergent Technologies Ltd., London (GB)

(72) Inventor: Arran Schlosberg, London (GB)

(21) Appl. No.: 18/202,715

(22) Filed: May 26, 2023

Related U.S. Application Data
(60) Provisional application No. 63/346,746, filed on May 27, 2022.

(51) Int. Cl. G06Q 30/08; G06Q 20/10; H04L 9/08; H04L 9/32

(52) U.S. Cl. CPC G06Q 30/08; G06Q 20/10; H04L 9/0825; H04L 9/3213; G06Q 2220/00

(57) ABSTRACT

A system and method for enabling cryptographically sealed (encrypted) auction bids for one or more items, from one or more bidders, based on an Elliptic-Curve Diffie-Hellman (ECDH) cryptographic key exchange on a blockchain-based smart contract. A Diffie-Hellman key exchange is a method for securely exchanging cryptographic keys over a public channel, and allows two parties that have no prior knowledge of each other to jointly establish a shared secret—a value known only to the parties involved in the exchange but not to any eavesdropper. This shared secret can be then used as a key to encrypt subsequent communications, such as a specific bid, using a symmetric-key cipher.

### CROSS REFERENCE TO RELATED APPLICATION

This application claims the benefit of priority of U.S. Provisional Application No. 63/346,746, filed May 27, 2022, entitled “Multi-Unit Sealed-Bid Auctions of the Ethereum Virtual Machine”, the disclosure of which is incorporated, in its entirety, herein by reference.

### TECHNICAL FIELD

The subject matter described herein relates to smart contracts on an implementation of the Ethereum Virtual Machine (EVM), and more particularly to employing smart contracts for multi-unit, sealed-bid auctions on the EVM.

### BACKGROUND

Ethereum is an open-source blockchain technology that can be used as a cryptocurrency, i.e. a digital currency that functions as a medium of exchange by providing a digital ledger for financial transactions, but which also includes smart contract functionality. A cryptocurrency is a tradable digital asset, as a representation of currency, implemented with blockchain technology that only exists digitally. A smart contract is a computer program that can be executed as part of a blockchain protocol's transactions to execute arbitrary functionality in addition to or instead of the transfer of currency, including initiating further currency transfer or execution of other smart contract functionality.

The term “distributed ledger” is often used to analogously describe blockchains like Ethereum, which enable a decentralized currency using fundamental tools of cryptography, or a “cryptocurrency”. The Ethereum protocols use cryptographic fundamentals that guarantee provenance of data, but not secrecy such that all information regarding transactions is publicly available. The native cryptocurrency of the Ethereum network is referred to as ETH (symbol E). A cryptocurrency behaves like a conventional currency because of the rules that govern what a party can and cannot do to modify the ledger. For example, an Ethereum address cannot spend more ETH than it has previously received, nor can it spend the same allocation of ETH more than once. These rules underpin all transactions on Ethereum and many other blockchains such as Bitcoin.

An Ethereum smart contract augments the intuitive rules of currency as they apply to ETH by storing code instructions and state-defining data at a specific address on the Ethereum blockchain. Data is stored in blocks of 256 bits, known as words. The smart contracts define rules and executable functions to be run on the EVM. Some smart contracts implement other cryptocurrencies on top of the native currency, and each may elect to enforce further rules. A standard set of behaviors known as ERC-20 govern the accepted functionality of fungible cryptocurrencies, also known as tokens, to allow for interoperability between smart contracts. As ETH itself does not conform to the ERC-20 standard, a token known as wrapped ETH (wETH) exists and can always be exchanged at parity for regular ETH.

Thus, instead of only a distributed ledger, Ethereum is a distributed state machine, i.e., a large data structure that holds not only all accounts and balances, but a machine state that can change from block to block according to a pre-defined set of machine rules, and which can execute arbitrary machine code as programmed and deployed by users of the network. The specific rules of changing state from block to block are defined by the EVM and configured by smart-contract code. Executing instructions in this manner is referred to as “on-chain” while executing instructions outside of the blockchain network is referred to as “off-chain”. Execution of instructions and validation of correct outcomes is performed in a process known as mining, by parties known as miners.

A user executing smart-contract functionality is charged ETH proportional to the computing power necessary to complete the full execution of a transaction. Each EVM operation has an associated cost in units known as “gas” that is proportional to the amount of computational effort that is required to execute the specific operation. For a given network state, the amount of gas required to execute a specific transaction is fixed while the price of a gas unit may fluctuate. Gas prices are denoted in gwei, which itself is a denomination of ETH. Each gwei is equal to 0.000000001 ETH (10⁻⁹ Ξ). As users incur fees for executing transactions it is imperative that gas usage is optimized. A proportion of transaction fees are paid to miners as reward for their involvement. If a transaction fails to complete without error, the gas units utilized up to and including the failure are still charged to the user. Some miners agree to accept transactions directly from users and not make them publicly available until mined. Some miners agree to not mine transactions that would otherwise fail and result in a charge to the user.

### SUMMARY

The present disclosure relates to systems and methods for enabling cryptographically sealed (encrypted) auction bids for one or more items, from one or more bidders, based on an Elliptic-Curve Diffie-Hellman (ECDH) cryptographic key exchange on a blockchain-based smart contract. Each specific bid can be revealed by using a symmetric-key cipher. The ECDH can be executed on a network supporting the Ethereum Virtual Machine (EVM), particularly the Ethereum Mainnet network, which requires sufficiently low gas to be economically feasible. Some steps of a method can be executed “off-chain” so as to realize further economical and computing resource benefits.

In one aspect, a method of conducting multi-unit, sealed-bid auctions on a blockchain-based network via deployment and execution of one or more smart contracts is disclosed. The method can include steps of opening an auction on a blockchain-based network using an item contract that represents one or more items to be auctioned, the opening including executing an auction contract by initiating, from an auctioneer, an elliptic-curve Diffie-Hellman (ECDH) cryptographic key exchange. The initiating can include storing, to the auction contract, a public key, a reserve price, and a number of the one or items to be auctioned. The steps can further include receiving, from one or more bidders, one or more bids from each bidder for the one or more items to be auctioned. The one or more bids can be prepared with an ECDH cryptographic key exchange specific to each of the one or more bids, each bid having a price value that is cryptographically sealed from all other parties on the blockchain-based network, except for the auctioneer, by a symmetric cipher for which the key is derived from the shared secret determined as part of a per-bid ECDH cryptographic key exchange, and the ciphertext bid can be coupled with the respective public key when stored by the auction contract.

The method can further include steps of calculating, by the auctioneer, a market-clearing price for the one or more items in the auction and an ordering of bids to determine one or more winning bids, and revealing or proving, by the auctioneer to all parties, the private key of the auctioneer, to allow any party to reveal the plaintext value of each bid using its respective public key along with the auctioneer's private key. The method can further include steps of confirming, by the auction contract, the plaintext value of each bid, the sorting of all winning bids based on the plaintext value, and the market-clearing price for the one or more items, and initiating, by the auction contract, payment for at least one of the one or more items from each successful bid received by the auctioneer. Each payment can include updating a token contract related to a cryptocurrency managed by the blockchain-based network to transfer a value associated with the plaintext value from the successful bidder to the auctioneer. The method can further include steps of marking winning bids to provide their associated bidder with permission to execute claiming of one or more items from the item contract, and enforcing restrictions to inhibit claiming by non-winning bidders.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to multi-unit sealed-bid auctions on a blockchain-based network, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a sequence diagram illustrating a process consistent with implementations of the current subject matter;

When practical, similar reference numbers denote similar structures, features, or elements.

### DETAILED DESCRIPTION

This document describes a system and method for enabling cryptographically sealed (encrypted) auction bids for one or more items, from one or more bidders, based on an Elliptic-Curve Diffie-Hellman (ECDH) cryptographic key exchange on a blockchain-based smart contract. A Diffie-Hellman key exchange is a method for securely exchanging cryptographic keys over a public channel, and which allows two parties that have no prior knowledge of each other to jointly establish a shared secret—a value known only to the parties involved in the exchange but not to any eavesdropper. This shared secret can be then used as a key to encrypt subsequent communications, such as a specific bid, using a symmetric-key cipher.

In some implementations, the ECDH is executed on a network supporting the Ethereum Virtual Machine, particularly the Ethereum Mainnet network, which requires sufficiently low gas to be economically feasible. Other blockchain networks and technologies can be used.

This mechanism of an ECDH key exchange can be extended with a set of algorithms that decide the set of winning bids and each winning bid's price paid: for example, and without limitation, uniform (the bid of the lowest winning or highest losing bid) vs. discriminatory (generalized first or second price; i.e. amount bid or next-highest respectively), etc. All such algorithms can allow for a reserve price that defines a lower bound on prices which, if not met, results in a partial sale of the total supply of the one or more items.

In some implementations, elliptic-curve multiplication is performed on the BN256 GI curve as it is available through a pre-compiled contract that requires minimal gas. In some implementations, cryptographic hashing is performed with the SHA3 function, also available as a pre-compiled contract. Let H represent any chosen cryptographic hash function. In some implementations, H is used as a key-derivation function H(x), where x is a coordinate of the shared secret derived with ECDH, used to uniformly distribute entropy of the coordinate over 256 bits. In some implementations the symmetric cipher used for encrypting bids is a single-block xor of plaintext with H(x).

In some implementations, some off-chain computation is performed inside an arithmetic circuit amenable to zero-knowledge proofs (ZKPs) and an appropriate elliptic curve and hash function are chosen for compatibility with the chosen circuit's properties. In such instances, the Ethereum smart contract verifies the proof.

In some implementations, the system employs a single contract for all auctions, or alternatively, one contract per auction. Bidders need to approve the contract to spend their cryptocurrency token, a standard procedure in the ERC-20 standard. Using a single contract requires only one such approval and also limits the risk of bidders interacting with a nefarious contract that may not properly implement the auction mechanism.

Using an individual instance of an Ethereum smart contract as an example, for each auction, let A be the auctioneer, and {B₀ . . . Bₙ} be a set of bidders. A single end user may submit one bid or may submit multiple bids. For the sake of explanation, Bi and A may be the same end user submitting different bids. To start a new auction, A creates an asymmetric key pair {d_{A}, Q_{A}=d_{A}·G} (where signifies elliptic-curve multiplication of a point by a scalar and G is the generator of the curve) and sends a transaction to the auction contract with their public key Q_{A}, to make that key available to all bidders {B₀ . . . Bₙ}.

To place a plaintext bid value Pᵢ, bidder Bi similarly creates a key pair {d_{Bi}, Q_{Bi}=d_{Bi}·G}, computes {xᵢ, yᵢ}=d_{Bi}·Q_{A}=d_{A}d_{Bi}·G, the standard ECDH procedure, and sends a transaction with ciphertext bid Cᵢ and their own public key as their sealed bid: {Cᵢ=Pᵢ⊕H(xᵢ), Q_{Bi}}. In some implementations, a non-elliptic-curve variation of the Diffie-Hellman protocol is used. This limits storage costs to cover the public key and for the ciphertext, which in some implementations is truncated and packed with public information such as the bidder's address and other arbitrary data. In some implementations, 40 bits is sufficient to capture bid values ranging from 10⁻⁶ Ξ to 10⁶ Ξ after scaling by a factor of 10¹⁸, leaving 160 bits for the bidder's address and a further 56 bits within a single word for arbitrary metadata, whether plaintext or encrypted.

Bidders can choose to discard their private keys dB, as an unsealing of all bids is performed by A revealing their private key d_{A}. Each bid can be reconstructed by computing {xᵢ, yᵢ}=d_{A}·Q_{Bi}=d_{A}d_{Bi}·G yielding the exact same shared secret as the bidder, and Pᵢ=Cᵢ⊕H(xᵢ) to reverse the single-block cipher as the xor operation ⊕ cancels itself. As each bidder chooses a different value for d_{Bi} only they and the auctioneer can decrypt their specific bid.

In some implementations, the algorithms to determine winning bidders and the prices paid are performed off-chain to save transaction fees and the results are submitted to the auction smart contract for verification on-chain by confirming the presence of necessary properties. Unsealing and sorting of all submitted bids can be performed off-chain and the correct unsealing and decreasing value of bids confirmed on-chain, either directly or by verification of a proof thereof. Similarly, calculation of price paid in uniform-pricing algorithms can be computed off-chain and equality with the equivalent bid performed on-chain. In some implementations the initiation of bid processing by the Auction Contract is restricted to the Auctioneer as they have an economic incentive not to discard legitimate and otherwise winning bids as this would result in a reduced market-clearing price and therefore reduced value received by the Auctioneer.

In some implementations, major contributions to gas consumption during unsealing are up to three or more cold storage data accesses (2100 each) to read the bid public key and the ciphertext, a single BN256 scalar multiplication (6000) to perform the ECDH protocol, and a Secure Hash Algorithm 3 (SHA3) operation with one word (36); any storage required post reveal can be packed into the existing ciphertext word for a further 5000 gas. Accordingly, in some implementations, processing a single bid requires a total of 17136 gas, plus: (a) either an ERC-20 payment transfer or modification of a ledger managed by the auction smart contract; (b) pricing-algorithm checks; and (c) general overhead. These gas consumption numbers are exemplary only, and can vary with each application or auction contract or transaction.

In some implementations, the Auction Contract or its nominated beneficiary receives a fee from the Auctioneer as either a fixed value or a portion of the total value paid by the winning Bidders. For uniform pricing algorithms a proportional fee can be computed after payment of all winning bids. For discriminatory pricing algorithms a running total of all payments can be tallied, and the fee computed from this total. In some implementations the fee transfer is performed from the Auctioneer to the Auction contract to minimize the total number of transfers and, accordingly, the amount of gas required.

In some implementations the Auction Contract maintains an internal ledger of deposited ETH instead of relying on an external token. In some implementations all winning bids are processed in a single transaction. In some implementations the internal ledger is locked against deposits and/or withdrawals and winning bids are processed in multiple transactions. In some implementations the transaction or transactions for processing the bids are submitted directly to miners who agree not to mine transactions that would otherwise fail for reasons including but not limited to a winning Bidder's token balance changing to become insufficient in a situation known as race condition—by submitting directly to these miners, the Auctioneer's private key is not revealed if the transaction fails. In some implementations the Auction Contract is deployed on a network with lower gas prices and the entirety of computation can be performed on-chain once the Auctioneer's private key is revealed. In some implementations the Auction Contract and Item contract are combined into a single smart contract. In some implementations the Token Contract does not use ERC-20 but manages an internal ledger under its own implementation or a new standard. In some implementations a winning bidder claims one or more Items via the Auction Contract, which acts as a proxy to the Item Contract which only accepts claims from the Auction Contract. In some implementations a winning bidder claims one or more Items directly from the Item Contract, which confirms the winning status with the Auction Contract before issuing the Item or Items.

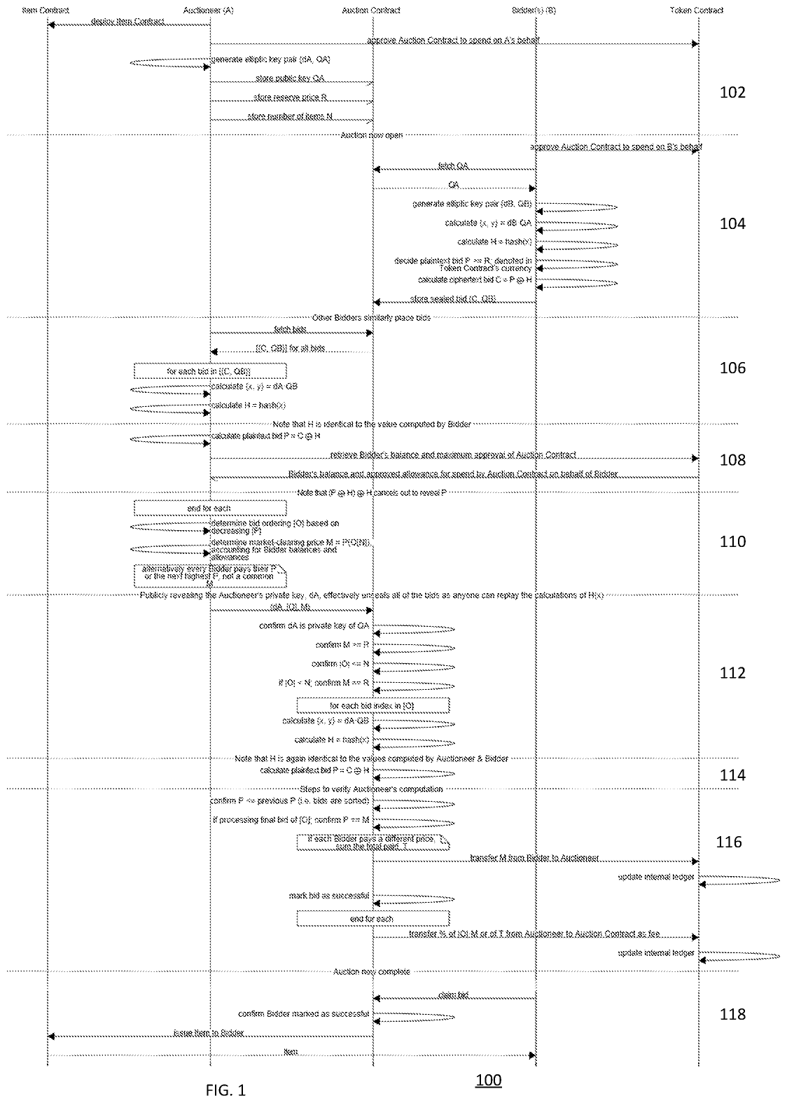

FIG. 1 is a sequence diagram illustrating a process 100 consistent with implementations of the current subject matter. The process 100 is a multi-unit, sealed-bid auction on the EVM, executed between an Auctioneer (A) and one or more Bidders (B) using a smart contract (“the Auction Contract”) for one or more items using an Item Contract for which the Bidders pay with the Token. The process 100 employs an algorithm in which the market-clearing price is the bid of the lowest-bidding winner. In the process 100, {X, Y, Z, . . . } means a logically grouped set of items, [X] means a list of Xs, and |X| means the number of Xs in a list.

The process 100 includes the general steps of opening an auction on the EVM with a public key from an elliptic key pair generated by the Auctioneer, at 102, receiving cryptographically “sealed” bids from one or more bidders each using their own elliptic key pair of an Elliptic-Curve Diffie-Hellman (ECDH) cryptographic key exchange, as shown at 104, and calculating a decryption key, at 106, in order to calculate a plaintext representation of each received sealed bid, at 108. The plaintext representation of each bid can be a numerical value in the form of a cryptocurrency such as wrapped Ether used by the EVM. The process 100 further includes steps of publicly revealing the Auctioneer's private key, at 112, to allow any party to “unseal” all bids and reveal their plaintext values.

The process 100 further includes verifying each bid, at 112, by another ECDH cryptographic key exchange performed on-chain to confirm aspects of the auction including, but not limited to, the market-clearing price (M) and bid ordering [O]. At 114, the plaintext bid prices are calculated, verifying the Auctioneer's computation. The process 100 further includes completing the auction, at 116, by accepting and processing successful (or winning) bids, and updating the internal ledger of the Token pertaining to the account of the successful bidder by their paid price, subject to a fee provided to the auction contract on the EVM. At 118, the bid-upon one or more items are issued to the successful bidder(s).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method of conducting a multi-unit, sealed-bid auction, the method comprising:
opening an auction using an auction contract from a blockchain-based network, the auction contract representing one or more items to be auctioned, the opening including executing the auction contract by initiating an elliptic-curve Diffie-Hellman (ECDH) eecryptographic key exchange, the initiating including storing a public key, a reserve price, and a number of the one or items to be auctioned with the auction contract;
receiving, from one or more bidders associated with the blockchain-based network, one or more bids for the one or more items to be auctioned, the one or more bids being prepared with an ECDH cryptographic key exchange specific to each of the one or more bids, each bid having a price value that is cryptographically sealed from all other parties on the blockchain-based network by a symmetric cipher for which the key is derived from a shared secret that is determined as part of a per-bid ECDH cryptographic key exchange, and each bid being coupled with the respective public key when stored by the auction contract;
calculating, based on the one or more bids, a market-clearing price for the one or more items in the auction and an ordering of the one or more bids to determine one or more winning bids;
revealing a private key to allow any of the one or more bidders to reveal a plaintext value of each bid using its respective public key along with the private key; and
confirming, by the auction contract, the plaintext value of each bid, the sorting of all winning bids being based on the plaintext value and the market-clearing price for the one or more items.

2. The method in accordance with claim 1, further comprising initiating, by the auction contract, payment for at least one of the one or more items from each successful bid received.

3. The method in accordance with claim 2, wherein each payment includes updating a token contract related to a cryptocurrency managed by the blockchain-based network to transfer a value associated with the plaintext value from the successful bidder

4. The method in accordance with claim 3, further comprising marking winning bids to provide their associated bidder with permission to execute claiming of one or more items from the item contract.

5. The method in accordance with claim 4, further comprising enforcing restrictions to inhibit claiming by non-winning bidders.

6. The method in accordance with claim 1, wherein the blockchain-based network includes an Ethereum Virtual Machine (EVM).

7. The method in accordance with claim 1, wherein initiating payment includes initiating payment of a fee from an auctioneer to the auction smart contract.

8. The method in accordance with claim 1, wherein the item contract and the auction contract comprise one smart contract.

9. A method of conducting multi-unit, sealed-bid auctions on a blockchain-based network via deployment and execution of one or more smart contracts by an auctioneer associated with the blockchain-based network, the method comprising:
opening an auction on a blockchain-based network using an item contract that represents one or more items to be auctioned, the opening including executing an auction contract by initiating, from an auctioneer, an elliptic-curve Diffie-Hellman (ECDH) cryptographic key exchange, the initiating including storing, to the auction contract, a public key, a reserve price, and a number of the one or items to be auctioned;
receiving, from one or more bidders, one or more bids from each bidder for the one or more items to be auctioned, the one or more bids being prepared with an ECDH cryptographic key exchange specific to each of the one or more bids, each bid having a price value that is cryptographically sealed from all other parties on the blockchain-based network, except for the auctioneer, by a symmetric cipher for which the key is derived from a shared secret determined as part of a per-bid ECDH cryptographic key exchange, the ciphertext bid being coupled with the respective public key when stored by the auction contract;
calculating, by the auctioneer, a market-clearing price for the one or more items in the auction and an ordering of bids to determine one or more winning bids;
revealing, by the auctioneer to all parties, the private key of the auctioneer, to allow any party to reveal the plaintext value of each bid using its respective public key along with the auctioneer's private key; and
confirming, by the auction contract, the plaintext value of each bid, the sorting of all winning bids being based on the plaintext value and the market-clearing price for the one or more items.

10. The method in accordance with claim 9, further comprising initiating, by the auction contract, payment for at least one of the one or more items from each successful bid received by the auctioneer, each payment including updating a token contract related to a cryptocurrency managed by the blockchain-based network to transfer a value associated with the plaintext value from the successful bidder to the auctioneer.

11. The method in accordance with claim 10, further comprising marking winning bids to provide their associated bidder with permission to execute claiming of one or more items from the item contract, and enforcing restrictions to inhibit claiming by non-winning bidders.

12. The method in accordance with claim 9, further comprising enforcing restrictions to inhibit claiming by non-winning bidders.

13. The method in accordance with claim 9, wherein the blockchain-based network includes an Ethereum Virtual Machine (EVM).

14. The method in accordance with claim 9, wherein initiating payment includes initiating payment of a fee from an auctioneer to the auction smart contract.

15. The method in accordance with claim 9, wherein the item contract and the auction contract comprise one smart contract.
